(19) United States
(12) Patent Application Publication
(10) Pub. No.: US 2022/0335519 A1
(43) Pub. Date: Oct. 20, 2022

(54) CONSOLIDATED CREDIT CARDS, AUTOMATED BILLING SYSTEMS, AND FINANCIAL TECHNOLOGIES FOR IMPROVED CREDIT CARD ACCOUNT OPERATIONS

(71) Applicant: GBT Technologies Inc., Santa Monica, CA (US)

(72) Inventors: Danny Rittman, San Diego, CA (US); Mo Jacob, Beverly Hills, CA (US)

(21) Appl. No.: 17/584,427

(22) Filed: Jan. 26, 2022

Related U.S. Application Data
(60) Provisional application No. 63/175,564, filed on Apr. 16, 2021.

(51) Int. Cl. G06Q 40/02; G06Q 20/24; G06Q 20/22; G06Q 20/40

(52) U.S. Cl. CPC G06Q 40/025; G06Q 20/24; G06Q 20/227; G06Q 20/4015

(57) ABSTRACT

Computer-implemented systems and methods of optimizing credit card benefits are provided. Disclosed systems and methods include an artificial intelligence unit having access to an institutional database including identification information for one or more credit financial institutions. A credit facilitation account incorporates one or more credit card accounts of a user. The artificial intelligence unit performs an analysis of credit card account features of each of the one or more credit card accounts. When the user makes a purchase using a credit card the system charges one of the one or more credit card accounts to provide the best value to the user based on the analysis. A consolidated credit system is also described including a credit card and a credit facilitation account linked to the credit card. The credit facilitation account incorporates one or more credit card accounts of a user.

### CROSS-REFERENCE TO RELATED APPLICATION

This application is a non-provisional of and claims priority to U.S. Patent Application Ser. No. 63/175,564, filed Apr. 16, 2021, which is hereby incorporated by reference herein in its entirety.

### FIELD

The present disclosure relates to consolidated credit cards, automated billing systems, and other financial technologies for improved credit account operations.

### BACKGROUND

Consumers often purchase goods or services with a limited understanding of the interest rate, credit card benefits (like mileage accumulation and similar), or to obtain a free incentive being offered by the remote retailer to induce the purchase of the goods or services. This can result in the consumer's poor financial management. When the charge for the purchased goods or services ultimately appears on the consumer's credit card billing statement, the consumer becomes aware that he or she is paying a high interest and/or losing benefits, or did not use a different credit card which would have provided more benefit due to a loyalty program or a promotion. These conditions create millions of credit card consumers who are in high debt or are not maximizing their benefits from loyalty programs or promotions.

When a consumer is placing a charge on a credit card, typically he or she does not take the time to verify the interest rate and the benefits of the card being used. Moreover, many credit cards offer a very low interest rate for the first one (1) year; hence, after this period the interest rate automatically becomes significantly higher, which causes the consumer to lose money.

The tendency of the consumer to purchase using a credit card often is compounded by the consumer's unfamiliarity with the credit card's interest rate and benefits. In addition, this tendency is further compounded by the industry practice of offering tempting credit cards at a very low interest rate for the first year. After a period of one year the credit card's interest rate rises significantly, causing the consumer to pay much higher monthly payments. Ultimately millions of consumers are going in debt due to the high interest rates that are automatically charged to their credit card accounts monthly. In addition, the user often is not aware of the credit card benefits (for example mileage plan) and is not utilizing them.

Accordingly, there is a need for an improved and automated distributed charging system, preventing consumers from using high interest credit cards. There is a need for a credit system and method that provides significant funds saving and debt prevention for credit card users. There is also a need for system and method that facilitates and optimizes utilization of credit card benefits for the consumer. There is a need for a consolidated credit card and credit card system that combines all a user's credit cards into one card.

### SUMMARY

The present disclosure, in its many embodiments, alleviates to a great extent the disadvantages and problems associated with known credit cards and credit systems by providing automatic, characterized, and prioritized consolidation of different credit cards into one card. The disclosure relates generally to a credit card automated billing system used by consumers and/or by retailers who sell goods or services, and more particularly, to an improved automated billing system which facilitates the distribution of charges for such goods or services on multiple credit cards in such a manner to financially benefit the customer, taking into account, e.g., lowest interest rate and better credit card benefits.

The one credit system described herein automatically prioritizes and charges according to the user's best value or to provide increased value to the user, which means financial benefit from, e.g., interest rate, benefits, miles, reward programs, promotions, etc. Furthermore, it consolidates all the user's lines of credit from his/her different credit cards into one large line of credit. Using disclosed systems, methods and processes, users may save enormous amount of money and gain all the possible additional benefits using their credit cards.

Exemplary embodiments of a computer-implemented automated billing system comprise an artificial intelligence unit having access to an institutional database including identification information for one or more credit financial institutions. The artificial intelligence unit also is in communication with a credit facilitation account which incorporates one or more credit card accounts of a user. The artificial intelligence unit performs an analysis of credit card account features of each of the one or more credit card accounts. When the user makes a purchase using a credit card the system charges one of the one or more credit card accounts to provide the best value to the user based on the analysis. The best value is the greatest financial benefit determined by the user's preferences and/or credit card account features. The system may be connected to a credit card accounts database and has the capability to charge or credit each credit card account. In exemplary embodiments, the credit card account features comprise interest rates, benefits, and/or rewards, and the best value may include the lowest interest rate.

The identification information may include an identification code for each of the one or more credit financial institutions. In exemplary embodiments, the system compares the credit financial institution identification codes to entries in the institutional database to verify the identity of each of the one or more credit financial institutions. The system may further comprise one more electronic circuits establishing a physical connection to the institutional database, the credit facilitation account, and/or the one or more credit card accounts. The system supports a web-based application and/or a client server independent application that is connected to a credit card accounts database. In exemplary embodiments, the artificial intelligence unit checks the user's geographical location and provides an alert if the purchase is at a geographical location different from the user's geographical location.

Exemplary methods of automatic billing comprise identifying one or more credit financial institutions with a credit card account associated with each credit financial institution, creating a credit facilitation account, and consolidating one or more of the credit card accounts into the credit facilitation account. Methods further comprise analyzing credit account features of each of the one or more credit card accounts and charging one of the one or more credit card accounts to provide the best value to the user based on the analysis when the user makes a purchase using a credit card. The charges may be automatically distributed to any of the user's credit cards to one of the one or more credit card accounts to provide the best value to the user based on the analysis.

Exemplary methods further comprise performing an electronic information input process to receive a credit financial institution identification code, the user's account identifier, credit card interest rates, credit card account current balance, credit card account available balance, and/or credit card account benefits and rewards. The input process may include receiving a credit financial institution identification code and the user's account identifier and determining whether the user's account identifier is valid or invalid. Exemplary methods provide encryption processes for security.

In exemplary embodiments, a consolidated credit system is provided, which comprises a credit card, a credit facilitation account linked to the credit card, and an artificial intelligence unit in communication with the credit facilitation account. The credit facilitation account incorporates one or more credit card accounts of a user. The artificial intelligence unit performs an analysis of credit account features of each of the one or more credit card accounts.

When the user puts a charge on the credit card the system distributes the charge to one of the one or more credit card accounts to provide the best value to the user based on the analysis. In exemplary consolidated credit systems, all lines of credit from the one or more credit card accounts are combined into a single line of credit associated with the credit facilitation account. The system may include an institutional database including identification information for one or more credit financial institutions, and the artificial intelligence unit has access to the institutional database.

In exemplary embodiments, the artificial intelligence unit checks the user's geographical location and provides an alert if the charge is put on the credit card at a geographical location different from the user's geographical location. Exemplary consolidated credit systems generate periodic statements providing account information from the one or more credit card accounts. The system also may generate a report detailing why the system distributed charges to the one or more credit card accounts. The consolidated credit system may include a 1024-bit encryption security system. One of the one or more credit card accounts of the user may be located outside the country of residence of the user.

Accordingly, it is seen that consolidated credit systems and systems and methods of optimizing credit card benefits are provided. These and other features of the disclosed embodiments will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a schematic of an exemplary embodiment of a computer-implemented automated billing system in accordance with the present disclosure;

FIG. 2 is a perspective view of exemplary credit cards in accordance with the present disclosure;

FIG. 3 is a process flow diagram of an exemplary embodiment of a computer-implemented automated billing system and method in accordance with the present disclosure;

FIG. 4 is a schematic and flow diagram of an exemplary embodiment of a computer-implemented automated billing system and method and information verification procedure in accordance with the present disclosure;

FIG. 5 is a schematic and flow diagram of an exemplary embodiment of a computer-implemented automated billing system and method in accordance with the present disclosure

FIG. 6 is a schematic and flow diagram of an exemplary embodiment of a computer-implemented automated billing system and method in accordance with the present disclosure;

FIG. 7 is a process flow diagram of an exemplary embodiment of a computer-implemented automated billing system and method in accordance with the present disclosure;

FIG. 8 is a process flow diagram of an exemplary embodiment of a computer-implemented automated billing system and method with security and verification procedures in accordance with the present disclosure;

FIG. 9 is a schematic and flow diagram of an exemplary embodiment of a computer-implemented automated billing system and method with security and verification procedures in accordance with the present disclosure;

FIG. 10 is a schematic of an exemplary embodiment of a smart location charge verification system in accordance with the present disclosure;

FIG. 11 is a schematic and flow diagram of an exemplary embodiment of a smart location charge verification system in accordance with the present disclosure;

FIG. 12 is a front view of an exemplary graphical user interface for a computer-implemented automated billing system and method in accordance with the present disclosure;

FIG. 13 is a front view of an exemplary graphical user interface for a computer-implemented automated billing system and method in accordance with the present disclosure; and

FIG. 14 is a block diagram of an exemplary embodiment of the internal structure of a computer in which various embodiments of the disclosure may be implemented.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure.

As used herein, the “present disclosure” refers to any one of the embodiments described herein, and any equivalents. Furthermore, reference to various aspects of the disclosure throughout this document does not mean that all claimed embodiments or methods must include the referenced aspects. Reference to materials, configurations, directions, and other parameters should be considered as representative and illustrative of the capabilities of exemplary embodiments, and embodiments can operate with a wide variety of such parameters. It should be noted that the figures do not show every piece of equipment, nor the materials, configurations, and directions of the various circuits and communications systems.

Disclosed embodiments include automated billing systems and methods. Credit card characteristics categorize typical credit card accounts. These characteristics are offered by the credit card companies to their customers and include best interest rates, membership fees, cash advanced, line of credit, benefits like mileage, gift certificates, and similar award programs. Instead of a user selecting and charging one of her credit cards arbitrarily or by credit availability so she misses out on other cards' lower interest rates and/or benefits, the systems and related methods automatically characterize and prioritize multiple credit card accounts. Thus, the user gets the most value from his or her credit cards. The credit card user can employ disclosed systems and methods at any point of sale, either brick-and-mortar or online, via a mobile app on a smartphone, an internet-based application, and/or via computer software, a standalone computer program, and the system also supports independent client server applications.

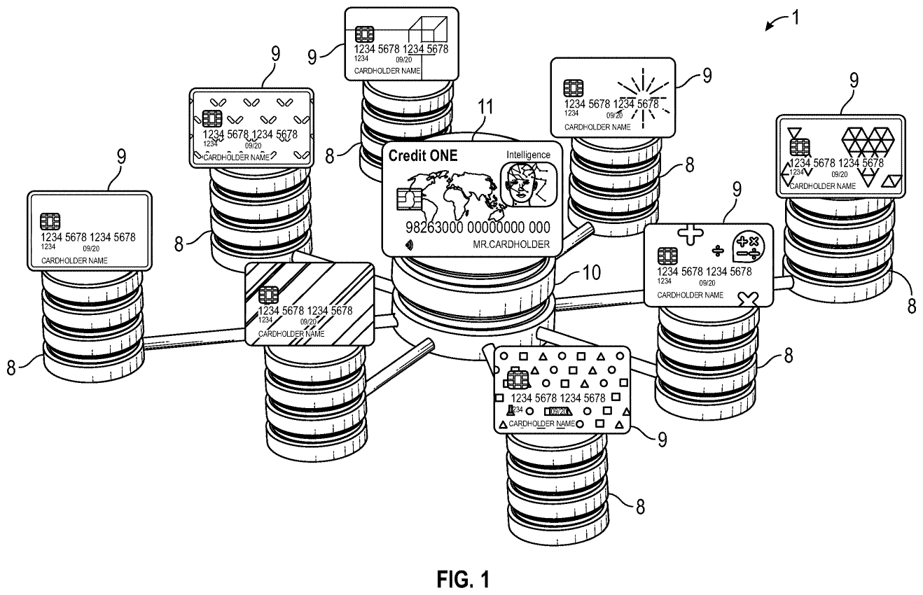

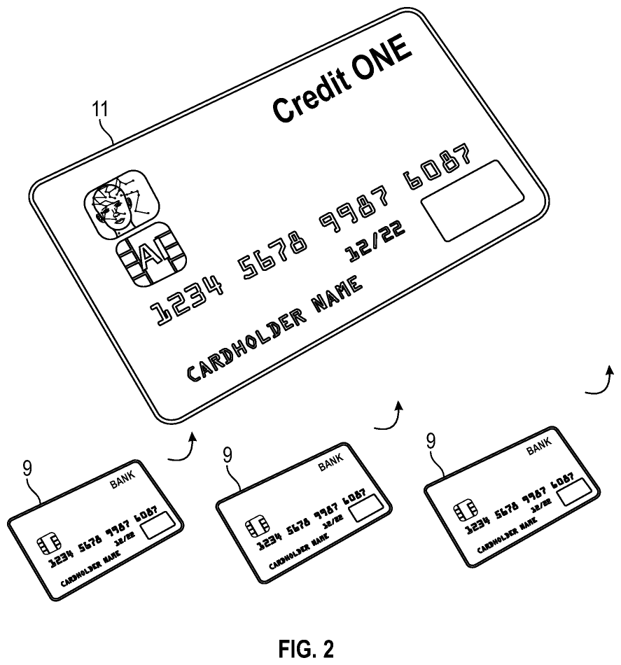

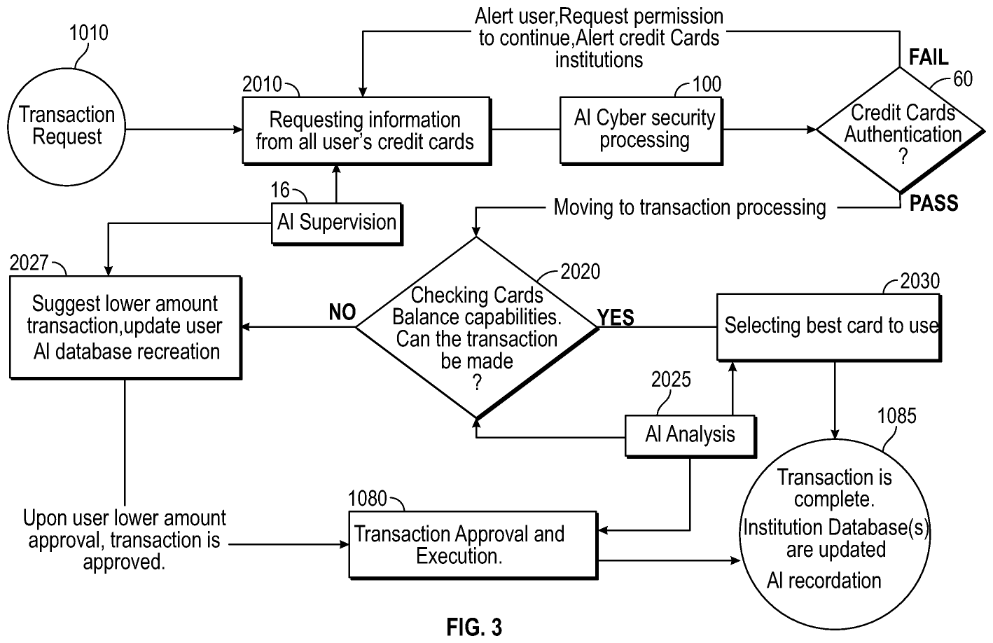

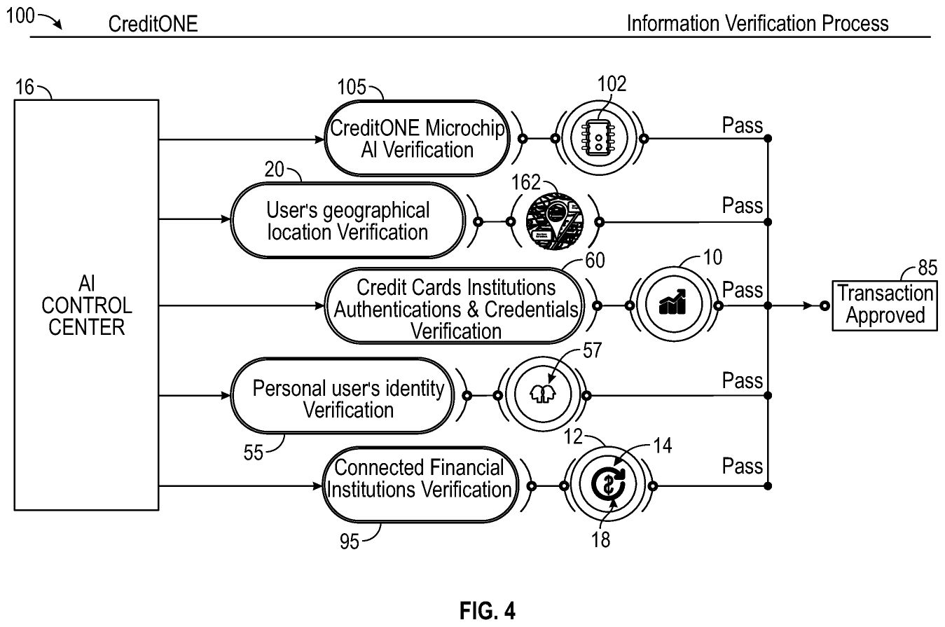

FIGS. 1-4 show exemplary embodiments of an automated billing system 1. As described in detail herein, this acts as an automated distributed payment processing system for generating authorized payments to credit financial accounts belonging to multiple users. The system 1 enables the user to combine all his or her individual credit cards accounts 8 into one credit facilitation account 10 providing one large available credit. In other words, it consolidates all the lines of credit 8 from his/her different credit cards 9 into one “big” line of credit, i.e., credit facilitation account 10, with all the available credit going into the central account 10. The user may be issued a credit card 11 associated with the credit facilitation account 10 to centralize transactions at points of sale. Exemplary systems include an institutional database 12 that contains identification information 14 for a number of credit financial institutions.

The system 1 includes an artificial intelligence (AI) unit 16, which is in communication with the credit facilitation account 10 and has access to the institutional database 12. The AI unit 16 analyzes 2025 each individual credit card account 8 to determine the account's characteristics that provide value to the user, such as interest rate, benefits, rewards, miles, reward programs, promotions, etc. Suitable electronic circuitry provides the requisite physical connections between the institutional database 12, the credit facilitation account, the various credit card accounts 8, and the AI unit 16. One or more processors are connected to the inputs (graphical user interface and databases) for receiving input information and processing the information.

Communications within the automated billing system 1 facilitate electronic information input of account identification information 14 from the institutional database 12 or from external sources if needed. As discussed in more detail herein, the AI unit 16 may receive that information either automatically or manually so the system is able to perform the security and verification procedures 100 needed to identify each of the individual credit card accounts 8 and financial institutions holding the accounts. Communication among the various user credit card accounts 8 enables receipt of amount information defining an amount to be charged or credited to the user, which also is inputted into the system. Exemplary embodiments receive inputs containing user transaction details from points of sale, whether brick-and-mortar, online, or via mobile applications.

In exemplary embodiments, the input information may include credit financial institution identification codes 18 identifying the credit financial institutions holding the user's credit financial accounts. These codes may enter the input information contemporaneously with the account information 14. The system 1 may use the account identification information 14 and credit financial institution identification codes 18 to automatically verify 95 that the credit card accounts and financial institutions are correct. In exemplary embodiments, it does this by comparing the codes to entries in the institutional database 12 and determining whether the code matches an entry in the database.

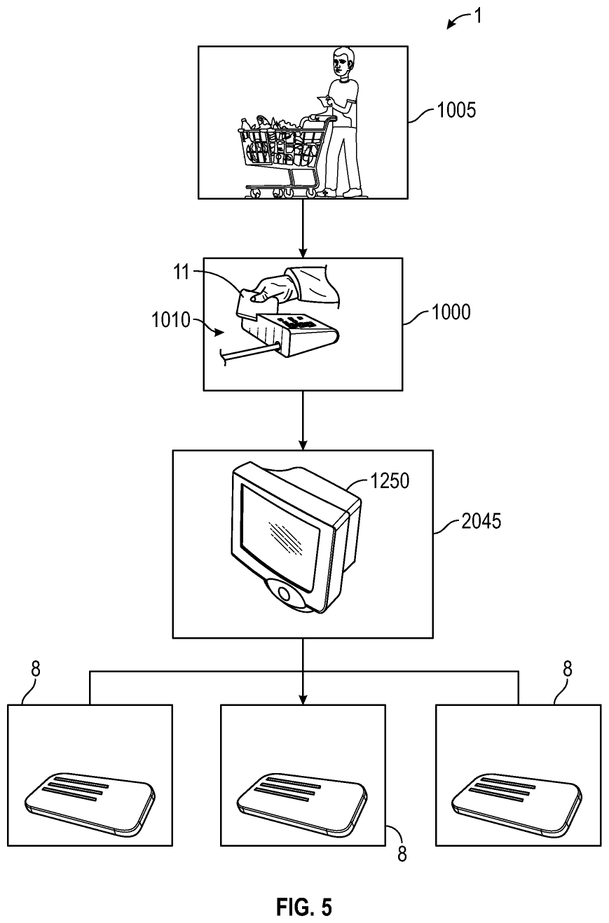

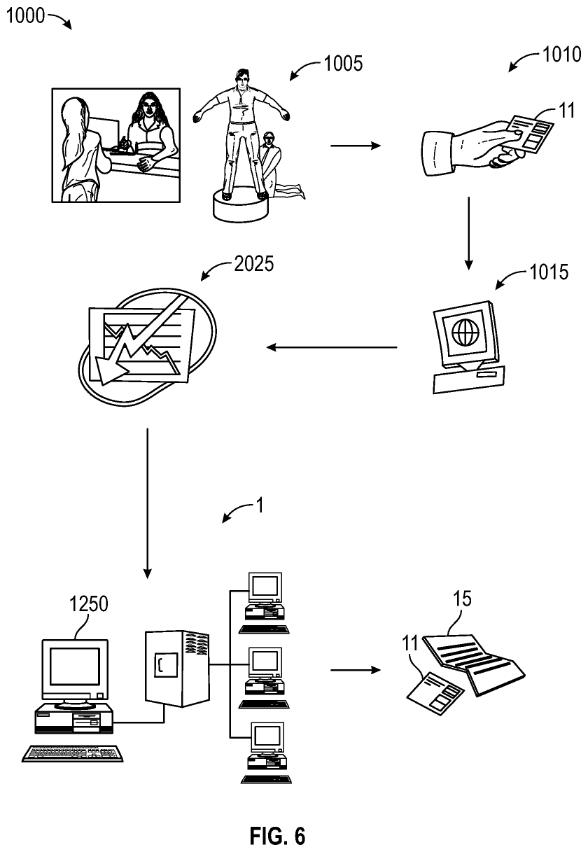

In exemplary embodiments, the computing system obtains in separate components the credit card accounts' benefits for analysis. The system may receive automated information taken from a credit card accounts database about each credit card account interest rate and benefits information. Exemplary one credit systems 1 automatically prioritize and charge one of the credit cards for each purchase according to the user's best interest, i.e., to provide the best value to the user. For example, as shown in FIG. 5, each time that a charge or credit is placed on any of the individual credit cards 8 in the system 1 or on a system-specific “OneCredit” credit card 11, the system automatically distributes 2045 the charge or credit to the available credit card account(s) 8 according to the lowest interest rate and benefits. This is done for the user's best interest and saves the user a significant amount of money over time. As best seen in FIGS. 5 and 6, when the user goes shopping 1005 (either physically or online) and conducts a credit card transaction 1010 with any of his credit cards 9, the AI unit 16 searches the various credit card accounts 8 to determine the one that will provide the most financial benefit for that transaction.

As mentioned above, the financial benefit would be derived from the characteristics and priorities (low interest rate, credit card accounts interest, mileage, gift points, etc.) associated with the credit card account 8. Often, the determinative factor will be lowest interest rate. The system 1 then charges or allocates the transaction amount to the individual credit card account 8 the AI unit 16 has determined is most beneficial. If the best value to the user would be derived from use of multiple credit card accounts 8, the system 1 may automatically split the transaction amount among multiple credit card accounts 8 to achieve the best overall interest rate and/or maximum rewards. The automated billing system 1 also covers refunds in a similar way, i.e., all refunds are credited to the best credit account(s) according to the user's optimal value and/or pre-set priorities. Exemplary systems can also provide a minimum payment due to cover all necessary credit card accounts.

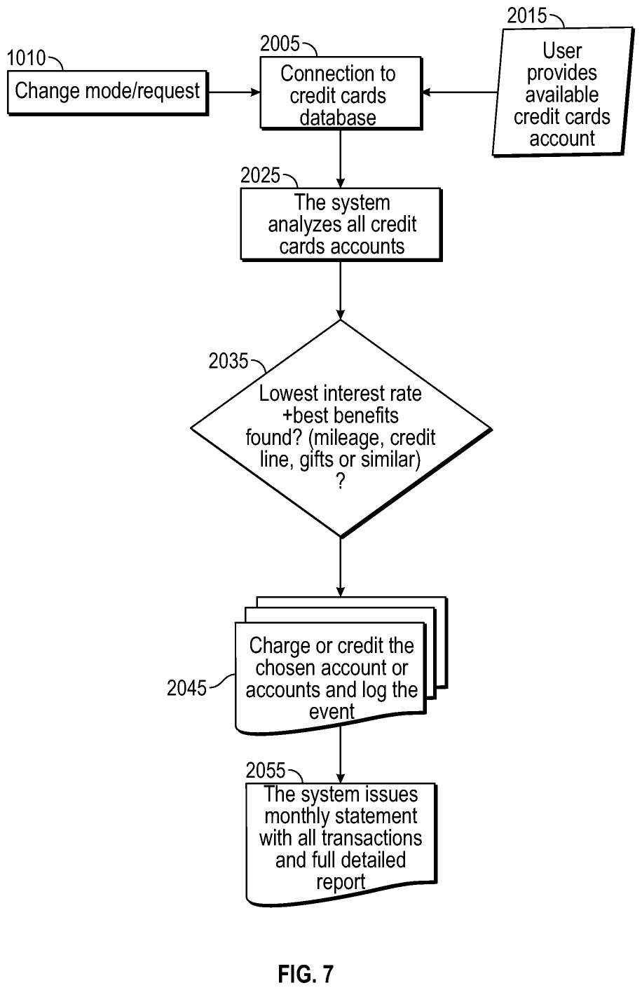

Referring to FIGS. 6 and 7, in exemplary embodiments the automated billing system 1 generates 2055 periodic statements 15 providing account information from the user's credit card accounts 8. More particularly, the user receives by mail (or via upload on computer or smartphone) a daily, weekly, or monthly statement that shows the total charges and makes one payment which will be distributed among the different accounts that she consolidates to this one credit account (credit card). The user can choose a “payment plan” in which case the system will block the full charge of the relevant credit card and will allocate the full charge into payment program with installments paid monthly, weekly, or any other period chosen by the user. As part of the periodic statement 15 or as a separate report, the system 1 also details and explains to the user how and why it distributed charges to the one or more credit card accounts, i.e., to which account each charge was made and the reasons for this account selection.

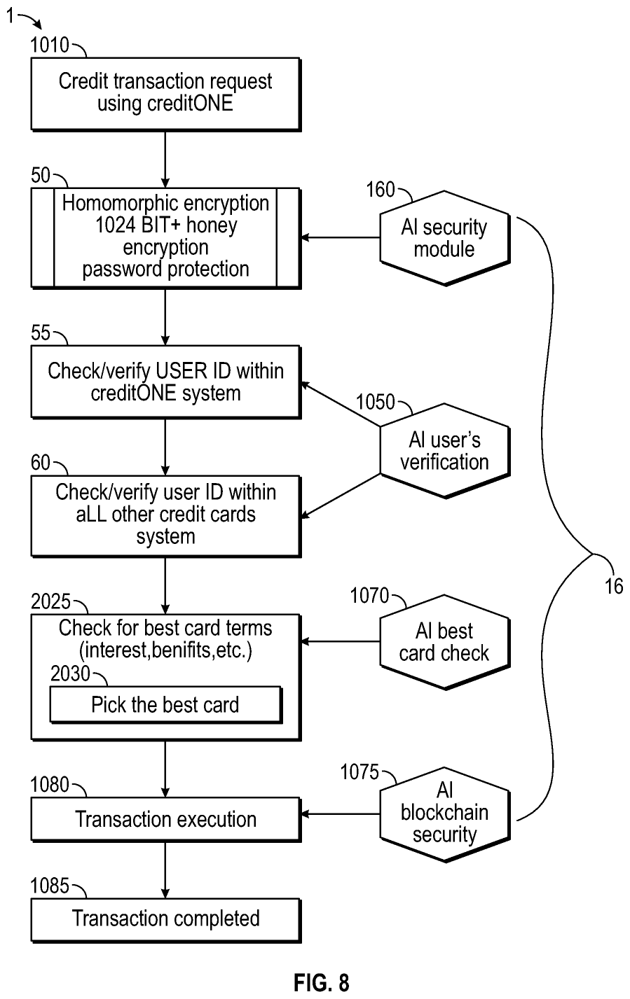

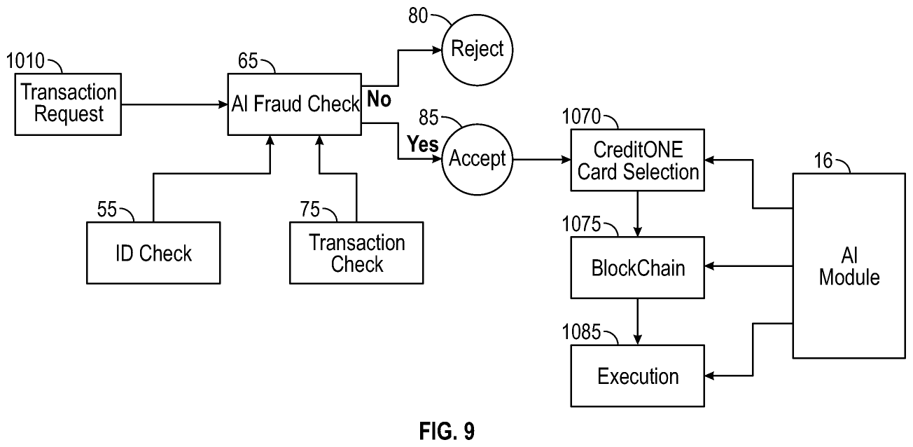

Turning to FIGS. 8 and 9, exemplary systems provide security and verification procedures 100 to maintain the safety and privacy of the user's financial information. There are encryption processes employed, and the system may include a 1024-bit encryption security system. For user access to the billing system 1 and/or when a credit transaction request 1010 is made 1010 by the user, security may include encryption and password protection 50, homomorphic encryption and/or HONEY encryption provided by the security module 160 of the AI unit 16. In exemplary embodiments, the system's security and verification procedures 100 include verification 105 of the single credit card microchip 102.

The AI unit 16 may perform a broad fraud check 65 including, but not limited to, an ID check 55 and transaction check 75. More particularly, the AI unit 16 may include a verification module 1050 that checks and verifies 55 the user's ID 57 within the system 1 as well as verifying 60 her ID in all the other credit card systems. If fraudulent activity is discovered, the system rejects 80 the requested transaction. If the IDs are verified and the rest of the fraud check 65 reveals no potentially fraudulent activity, the requested transaction is accepted 85, and the system 1 proceeds with the best card check 1070, performing the analysis 2025 for the best credit card to charge 2030 for the benefit of the user. The transaction details are recorded on a blockchain 1075, and the transaction procedure continues 1080 to completion/execution 1085.

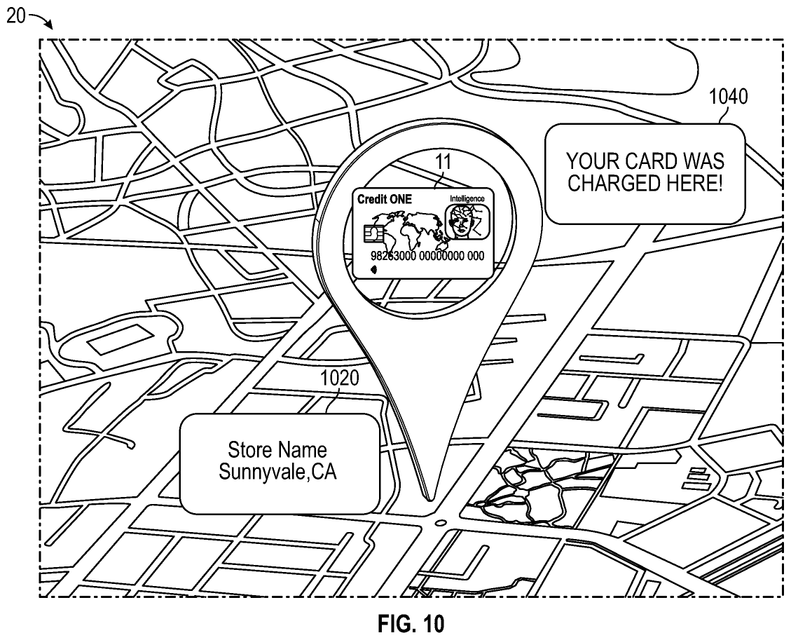

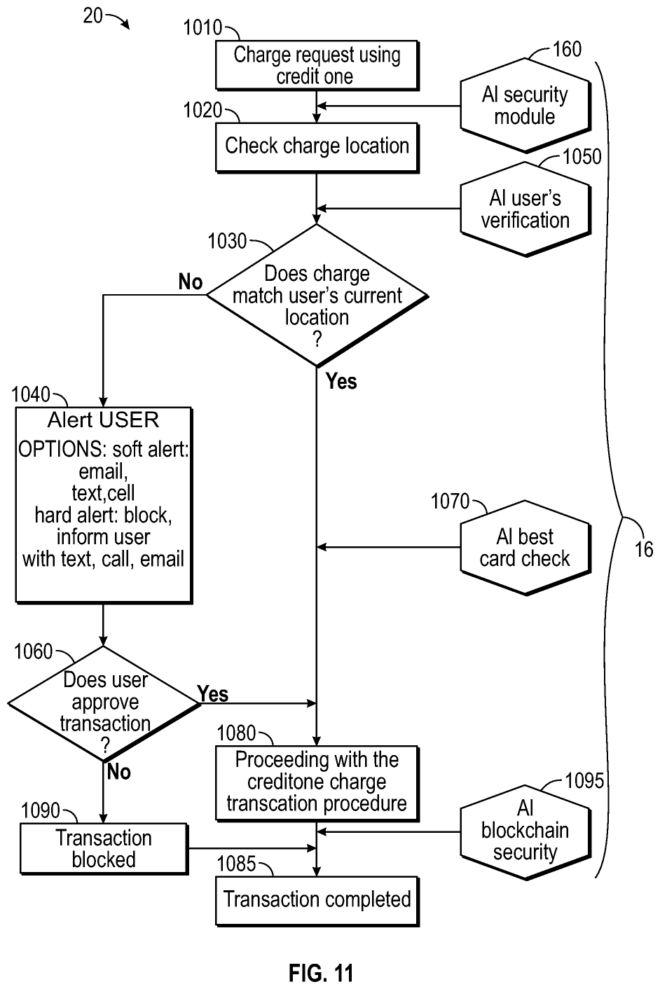

With reference to FIGS. 10 and 11, exemplary automated billing systems 1 have a smart location charge verification system 20 to provide an alert and potentially block a charge that is not typical for the user's location. As part of this location verification, the AI unit's security module 160 checks the user's geographical location and provides an alert if the purchase is done in a different location 162. For example, if the user's credit card is charged 1010 in New York, but the user lives in San Diego or is temporarily outside of New York, the AI unit would verify 1050 the user's current location (with the user's pre-set permission) and check the charge location 1020. The verification system 20 queries 1030 whether the charge location matches the user's current location.

If the charge is at a different location 162 than the user, the verification system 20 will alert 1040 the user. This alert 1040 could be a text message or other form of notification requesting confirmation that the user made the purchase at issue at that location. If the user approves 1060 the transaction, the best card check 1070 for which is the best credit card to use (as described above) is performed by the billing system 1 and the transaction procedure 1080 proceeds to completion 1085, with the attendant blockchain security 1095. If the user does not approve the transaction, then it is blocked 1090.

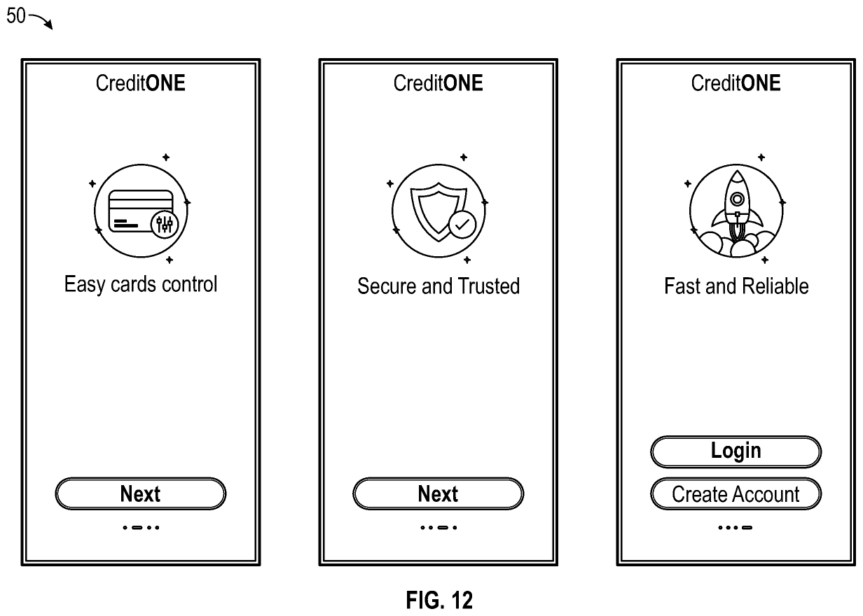

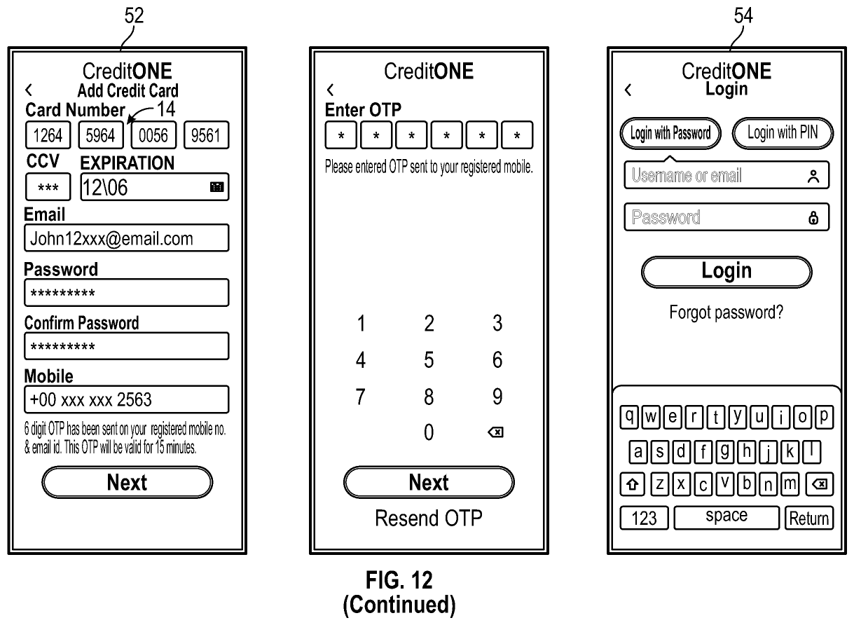

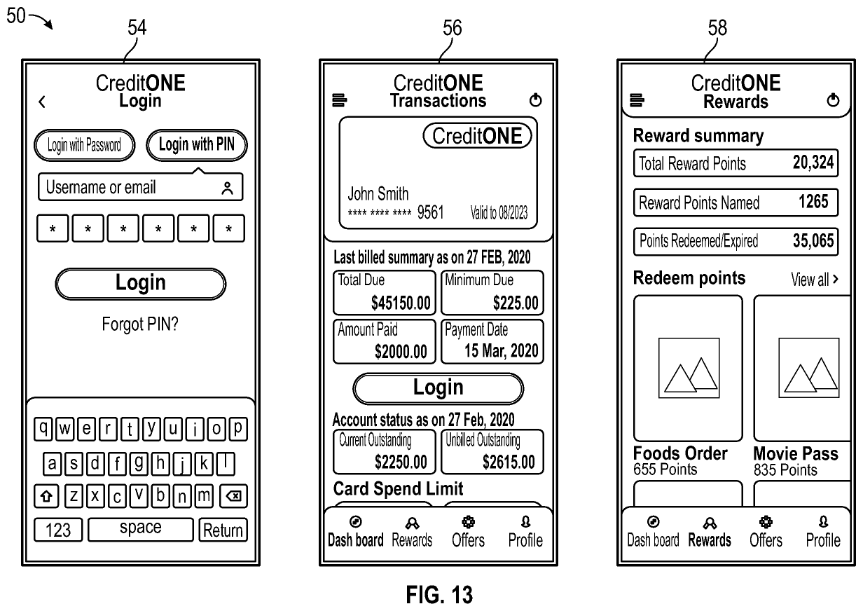

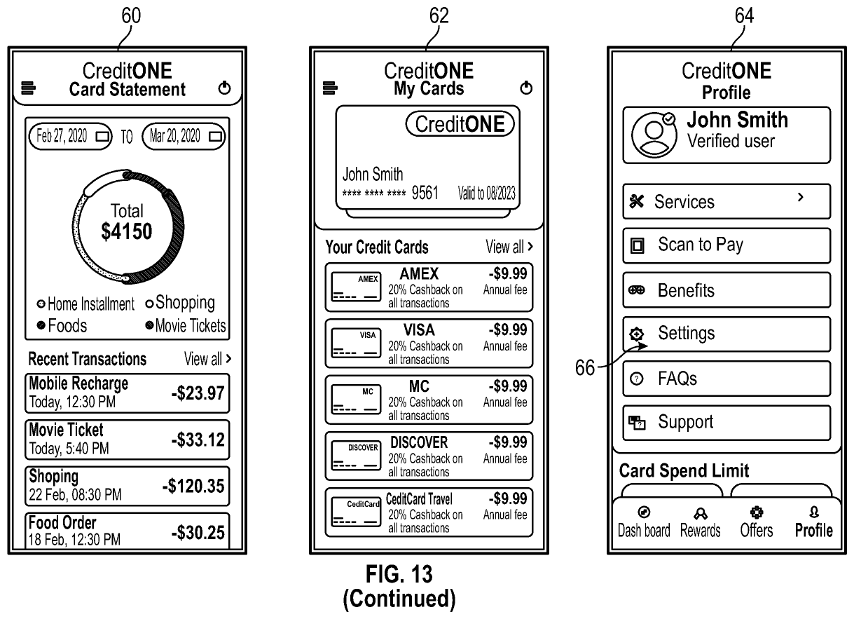

In operation, as illustrated in FIGS. 12 and 13, the user may register with the consolidated credit card system 1 through a sign-up page 52 of the graphical user interface 50 on a personal computer or smartphone. The user creates his or her security credentials such as username, password, and biometric and/or facial features for access to the system. The system then displays a login page 54. The system may prompt the user to enter 2015 his credit card account details 14, including credit financial institution information.

In exemplary embodiments, the sign-up/input page 52 provides a single input location with fields for receiving a username, user identifying information, credit financial institution identification number, user account identifier, and the amount to be charged or credited from the user's account. The system 1 supports international credit accounts and supports all credit card financial institutions worldwide, so the user can be located in any country and input information for accounts both inside and outside her country of residence. A profile page 64 displays basic user profile information and has buttons the user can press to jump to other pages, such as a settings button 66 moving the user to a settings page that allows the user to adjust various settings, such as notifications, privacy, and account/security settings. A transactions page 56 displays the credit card transactions the user has done. The user can also view the various rewards offered by her credit cards on the rewards page 58. The user can see his credit card statements on a statement page 60 and can get an overview of all his credit cards on the My Cards page 62.

In exemplary embodiments, an electronic information input process is performed to obtain the information required to identify the credit financial institutions and credit card accounts associated with each institution. This may include linking with a local or remote institutional database 12 or other external source that contains credit financial institution identification codes 18 identifying the credit financial institutions holding the user's credit financial accounts. The input process can include obtaining a credit financial institution identification code, the user's account identifier, credit card interest rates, credit card account current balance, credit card account available balance, and/or credit card account benefits and rewards.

With access to the requisite information, institution verification processes can be performed by comparing the user's credit financial institution details to the financial institution identification codes 18 in the institutional database 12. The system 1 may use the account identification information 14 and credit financial institution identification codes 18 to automatically verify that the credit card accounts and financial institutions are correct by determining whether the user's account identifier is valid or invalid. If any of the user's credit financial institutions are not found in the institutional database 12 or any other account discrepancy is discovered, then an error indication is generated and provided to the user.

The user then creates a credit facilitation account 10 and combines all her individual credit card accounts 8 into it. The user can then begin to use the secured web-based methods via a personal computer 1250 or smartphone-based methods to define and prioritize his credit accounts automatic selection according to their priorities. The user can enter his criteria for prioritizing charges to his credit card accounts. For example, the user could set up the system to charge the credit card with the lowest interest rate, to charge the credit card with the highest credit limit, or to charge the credit card providing the desired benefit, such as reward points or flight miles. In exemplary embodiments, this user prioritization would serve as the best value the system determines for the user for certain transactions. Also, the system provides a minimal payment due to cover all necessary credit card accounts. The user can set up the system to pay the minimum amount required or more according to her wishes.

The system 1 requests 2010 information from the user's credit accounts and analyzes 2025 the credit account features. The system 1 automatically identifies the characteristics of each of the user's credit accounts that provide value to the user, such interest rate, credit limit, rewards, benefits, etc., so it can apply the user's desired criteria or automatically charge the credit card account for the user's best value. The most beneficial account, the account that provides the best value is defined 2035 by the system according to its characteristics and benefits. These characteristics include low interest rate, additional benefits (mileage, gift points, line of credit, etc.) provided by the credit card companies and/or financial institutions.

Once the user has set up the consolidated credit card account system 1 and the information input, analysis, and verification processes have been completed, the user can begin to make credit card purchases using the system. For a transaction, he or she can use a primary, consolidated “OneCredit” card 11 directly linked to the credit facilitation account 10. Alternatively, she can use any one of her regular credit cards. When the user makes a purchase 1000, the charge request 1010 is received 1015 by the system 1 and connection 2005 to the credit cards database is made. In exemplary embodiments, the chip 102 in the credit card 11 sends a signal to the system 1. The user can make a purchase from anywhere and any type of merchant because the system supports all types of charges or credits transactions, such as a merchant store, Internet on-line secure web site and/or via telephone.

The automated billing system 1 then performs the credit card accounts analysis 2025 for this transaction to determine which credit card account or combination of accounts would provide the user's best value. This analysis considers the characteristics of the various accounts such as interest rates, credit limits, benefits, rewards, etc. In exemplary embodiments, the interest rate is weighted most highly in the analysis and is the determinative factor in selecting which credit card account to charge. If the user has input desired criteria such as, e.g., accumulating travel miles through a mileage redemption program, then that feature would be weighted most highly. Once this analysis 2025 is complete, the system may perform a balance capability check 2020 for the credit account it has selected to ensure that the transaction can be made. If the selected credit account cannot support the transaction, the system suggests 2027 a lower amount for the transaction and updates the user. The AI unit records the discrepancy in its database. If the selected credit account can support the transaction, the charge is automatically distributed 2045 to the credit card account or accounts 8 to provide the best value based on the analysis 2025.

The user can elect to receive automated account statements 15 generated periodically 2055. Provided daily, weekly, monthly, quarterly, or annually, the statements provide comprehensive information to the user about all his credit card accounts 8, including the credit facilitation account 10. By reviewing the statements 15, the user can see all charges and refund information made by the system, including the charges and refunds that were made to each credit card account. Advantageously, the statement 15 also provides a detailed description to the user of the charge or credit routed to the user's most beneficial credit card accounts. More particularly, the user statement 15 contains explanations of how and why each charge was routed to a particular credit card account, including which criteria were used and the analysis performed to conclude that a particular account was the best one to charge for a specific transaction.

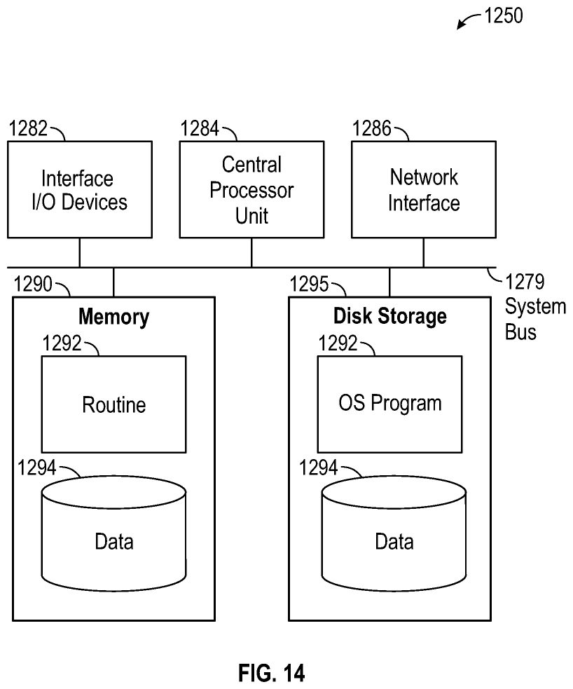

FIG. 14 shows an exemplary internal structure of a computer 1250 in which various embodiments of the present disclosure may be implemented. The computer 1250 contains a system bus 1279, where a bus is a set of hardware lines used for data transfer among the components of a computer or processing system. Bus 1279 is essentially a shared conduit that connects different elements of a computer system (e.g., processor, disk storage, memory, input/output ports, network ports, etc.) that enables the transfer of information between the elements. Attached to system bus 1279 is I/O device interface 1282 for connecting various input and output devices (e.g., sensors, transducers, keyboard, mouse, displays, printers, speakers, etc.) to the computer 1250. Network interface 1286 allows the computer 1250 to connect to various other devices attached to a network.

Memory 1090 provides volatile storage for computer software instructions 1292 (e.g., instructions for the processes/calculations described above and data 1294 used to implement embodiments of the present disclosure). Disk storage 1295 provides non-volatile storage for computer software instructions 1292 and data 1294 used to implement embodiments of the present disclosure. Central processor unit 1284 also is attached to system bus 1279 and provides for the execution of computer instructions.

In an exemplary embodiment, the processor routines 1292 (e.g., instructions for the processes/calculations described above) and data 1094 are a computer program product (generally referenced 1292), including a computer readable medium (e.g., a removable storage medium such as one or more DVD-ROMs, CD-ROMs, diskettes, tapes, etc.) that provides at least a portion of the software instructions for exemplary embodiments. Computer program product 1292 can be installed by any suitable software installation procedure, as is well known in the art.

In another embodiment, at least a portion of the software instructions may also be downloaded over a cable, communication and/or wireless connection. Further, the present embodiments may be implemented in a variety of computer architectures. The computer of FIG. 14 is for purposes of illustration and not limitation. In some embodiments of the present disclosure, the system may function as a computer to perform aspects of the present disclosure.

Thus, it is seen that systems and methods of automated billing and consolidated credit cards are provided. It should be understood that any of the foregoing configurations and specialized components or connections may be interchangeably used with any of the systems of the preceding embodiments. Although illustrative embodiments are described hereinabove, it will be evident to one skilled in the art that various changes and modifications may be made therein without departing from the scope of the disclosure. It is intended in the appended claims to cover all such changes and modifications that fall within the true spirit and scope of the present disclosure.

What is claimed is:

1. A computer-implemented automated billing system comprising:
an artificial intelligence unit;
an institutional database including identification information for one or more credit financial institutions, the artificial intelligence unit having access to the institutional database;
a credit facilitation account incorporating one or more credit card accounts of a user, the artificial intelligence unit being in communication with the credit facilitation account;
wherein the artificial intelligence unit performs an analysis of credit card account features of each of the one or more credit card accounts; and
wherein when the user makes a purchase using a credit card the system charges one of the one or more credit card accounts to provide the best value to the user based on the analysis.

2. The computer-implemented automated billing system of claim 1 wherein the credit card account features comprise one or more of: interest rates, benefits, and rewards.

3. The computer-implemented automated billing system of claim 2 wherein the best value includes the lowest interest rate.

4. The computer-implemented automated billing system of claim 1 wherein the identification information includes an identification code for each of the one or more credit financial institutions.

5. The computer-implemented automated billing system of claim 4 wherein the system compares the credit financial institution identification codes to entries in the institutional database to verify the identity of each of the one or more credit financial institutions.

6. The computer-implemented automated billing system of claim 1 further comprising one or more electronic circuits establishing a physical connection to one or more of: the institutional database, the credit facilitation account, and the one or more credit card accounts.

7. The computer-implemented automated billing system of claim 1 wherein the artificial intelligence unit checks the user's geographical location and provides an alert if the purchase is at a geographical location different from the user's geographical location.

8. A method of automatic billing, comprising:
identifying one or more credit financial institutions with a credit card account associated with each credit financial institution;
creating a credit facilitation account;
consolidating one or more of the credit card accounts into the credit facilitation account;
analyzing credit account features of each of the one or more credit card accounts; and
charging one of the one or more credit card accounts to provide the best value to the user based on the analysis when the user makes a purchase using a credit card.

9. The method of claim 8 further comprising automatically distributing charges to any of the user's credit cards to one of the one or more credit card accounts to provide the best value to the user based on the analysis.

10. The method of claim 8 further comprising performing an electronic information input process to receive one or more of: a credit financial institution identification code, the user's account identifier, credit card interest rates, credit card account current balance, credit card account available balance, and credit card account benefits and rewards.

11. The method of claim 10 wherein the input process includes receiving a credit financial institution identification code and the user's account identifier and further comprising determining whether the user's account identifier is valid or invalid.

12. The method of claim 10 further comprising providing encryption processes for security.

13. A consolidated credit system comprising:
a credit card;
a credit facilitation account linked to the credit card, the credit facilitation account incorporating one or more credit card accounts of a user; and
an artificial intelligence unit in communication with the credit facilitation account;
wherein the artificial intelligence unit performs an analysis of credit account features of each of the one or more credit card accounts; and
wherein when the user puts a charge on the credit card the system distributes the charge to one of the one or more credit card accounts to provide the best value to the user based on the analysis.

14. The consolidated credit system of claim 13 wherein all lines of credit from the one or more credit card accounts are combined into a single line of credit associated with the credit facilitation account.

15. The consolidated credit system of claim 13 wherein the artificial intelligence unit checks the user's geographical location and provides an alert if the charge is put on the credit card at a geographical location different from the user's geographical location.

16. The consolidated credit system of claim 13 wherein the system generates periodic statements providing account information from the one or more credit card accounts.

17. The consolidated credit system of claim 13 wherein the system generates a report detailing why the system distributed charges to the one or more credit card accounts.

18. The consolidated credit system of claim 13 wherein the system includes a 1024-bit encryption security system.

19. The consolidated credit system of claim 13 wherein one of the one or more credit card accounts of the user is located outside the country of residence of the user.

20. The consolidated credit system of claim 13 further comprising an institutional database including identification information for one or more credit financial institutions, the artificial intelligence unit having access to the institutional database.
